(19) United States
(12) Patent Application Publication
(10) Pub. No.: US 2010/0032034 A1
(43) Pub. Date: Feb. 11, 2010

(54) GAS VALVE WITH DUAL FUEL GAS CAPABILITY

(76) Inventors: Qibiao Xie, Zhongshan City (CN); Rui-Yuan Hsiao, Zhongshan City (CN)

Correspondence Address: KELLY LOWRY & KELLEY, LLP, 6320 CANOGA AVENUE, SUITE 1650, WOODLAND HILLS, CA, 91367, US

(21) Appl. No.: 12/534,701

(22) Filed: Aug. 3, 2009

(30) Foreign Application Priority Data
Aug. 5, 2008 (CN) 200810030043.9

(51) Int. Cl. F16K 11/02

(52) U.S. Cl. 137/605

(57) ABSTRACT

A gas valve with dual fuel gas includes a valve body having a valve core, an actuating shaft mounted with said valve core, a nozzle equipped on the valve body, and a gas inlet connecting with a gas compensation passage. The gas compensation passage has a sealing device used for opening or sealing the gas compensation passage. The valve core has a gas source passage, a main orifice and an air-compensation orifice. The sealing device has a position-limit means controlling the operation range of the sealing device. A position-limit means is provided for controlling the operation range of the sealing device for the purpose of solving the problem that the sealing device may drop off from the gas compensation passage and for the convenience of controlling the flow of compensatory gas.

### BACKGROUND OF THE INVENTION

1. Field of the Invention

The present invention relates to a gas valve. More particularly, a new gas valve can adopt a dual fuel gas source.

2. Description of the Related Art

It is well known that different fuel gasses have different combustion parameters, such as thermic load value, combustion potential, Wobbe index, etc. According to the gas character, different gas valves have to be adapted for different gas sources to make maximum use of heat energy. Traditionally, one gas valve is adapted for one corresponding gas source. If the gas source is changed, the gas valve or its assembly has to be changed accordingly to get stable combustion on the same combustor. The traditional gas valve is thereby very inconvenient and causes the resource waste problem. Additionally, it has risk and may cause disaster changing the gas valve by the user himself. To solve these problems, there is one type of gas valve having gas compensation passage in valve body. A sealing device installed in the gas compensation passage controls the opening and sealing of the passage. This gas valve has a fault in that it does not have any position-limit means. As a result, the sealing device may drop off from the passage in the process of regulating the passage. Moreover, this gas valve is not inconvenient for controlling the amount of compensatory fuel gas.

### SUMMARY OF THE INVENTION

In view of the above-described problems, the present invention provides a gas valve specially designed to overcome the faults. The gas valve can prevent the sealing device from dropping off from the gas compensation passage. Moreover, the gas valve is convenient for controlling the flow of compensatory fuel gas.

To achieve the objective, a gas valve with dual fuel gas comprises a valve body having a valve core, an actuating shaft mounted with said valve core, a nozzle equipped on said valve body, a gas inlet connecting a gas compensation passage, a sealing device equipped in said gas compensation passage, and said sealing device used for opening or sealing the gas compensation passage. Said valve core is fitted with the gas source passage, and has a main orifice and an air-compensation orifice connecting the gas source passage. A position-limit means is fitted on said sealing device to control the operation range of the sealing device.

One optimal solution of the present invention provides a sealing device including a sealing bolt in the valve body and a sleeve in the gas compensation passage. The sealing bolt is inserted into the sleeve through a cylinder at one end. The cylinder is used to seal the gas compensation passage. A sealing ring is installed between the sealing bolt and the sleeve. The sleeve has an annular recess on its outside lateral wall. The annular recess has an orifice at the bottom. The annular recess connects to the gas compensation passage.

Another optimal solution provides a sealing device including a sealing bolt in the valve body, said sealing bolt having an annular recess, a sealing ring fitted in said annular recess, and said sealing bolt has a cone connecting a sealing flake at one end.

The above-mentioned position-limit means includes a strip-shaped slot mounted aslant on the valve body, a position-setting stick inserted into the strip-shaped slot and fixed on the lateral wall of the sealing bolt at one end.

The present invention provides a position-limit means equipped in a sealing device in the valve body. The position-limit means limits the operation range of the sealing device and solves the problem of the sealing device dropping off from the gas compensation passage. In this way, the area of gas compensation passage is reduced, and the amount of flow can be controlled conveniently.

### BRIEF DESCRIPTION OF THE DRAWINGS

FIG. 1 is a perspective view of the invention;

FIG. 2 is a partial decomposition perspective view according to FIG. 1;

FIG. 3 is a sectional view of the invention;

FIG. 4 is a partial sectional view of the invention;

FIG. 5 is a general view of the invention;

FIG. 6 is a perspective view of the valve core;

FIG. 7 is a sectional view of the valve core; and

FIG. 8 is a construction view of another solution.

### DETAILED DESCRIPTION OF THE INVENTION

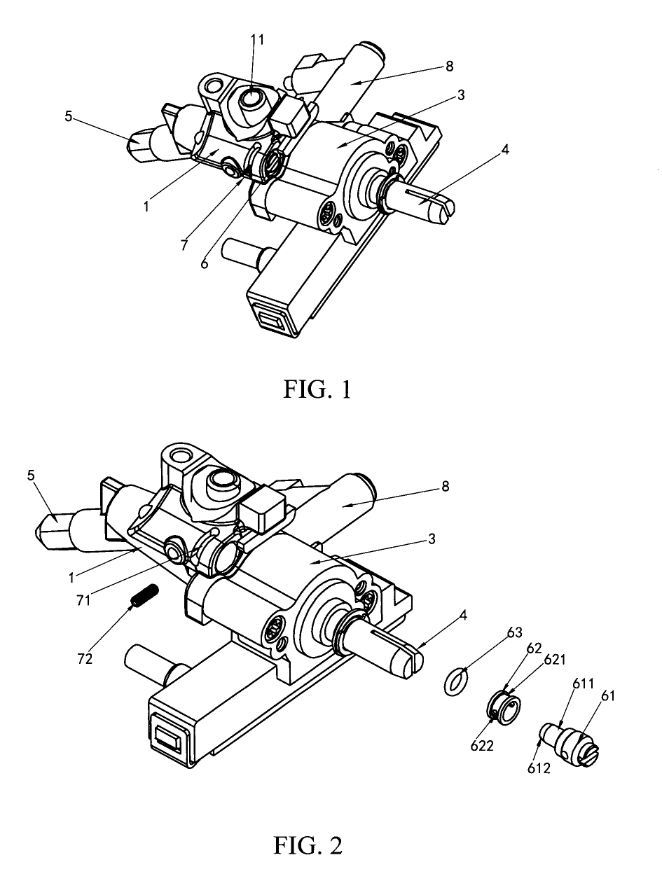

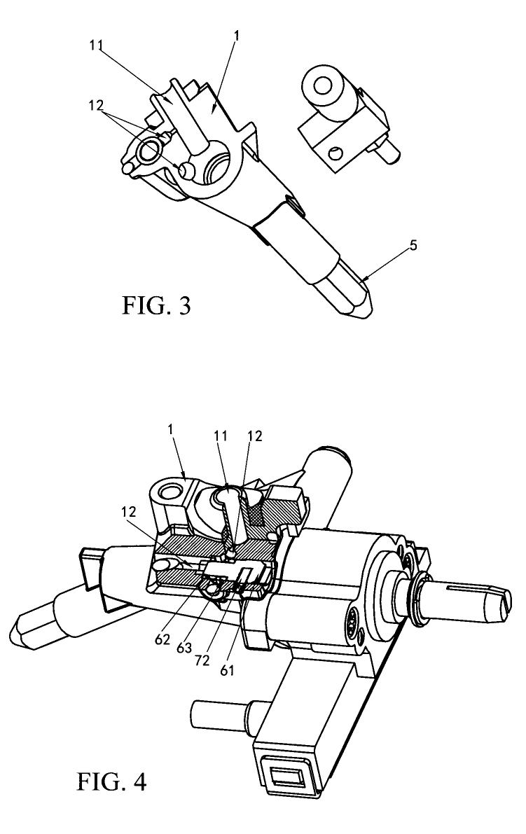

With reference to FIG. 1 to FIG. 7, the present invention discloses a gas valve which is capable of adopting dual fuel gas. The gas valve comprises a valve body 1, a valve core 2, a valve cover 3, an actuating shaft 4 mounted with said valve core 2, a nozzle 5 equipped in said valve body. The actuating shaft 4 can control rotation of the valve core 2.

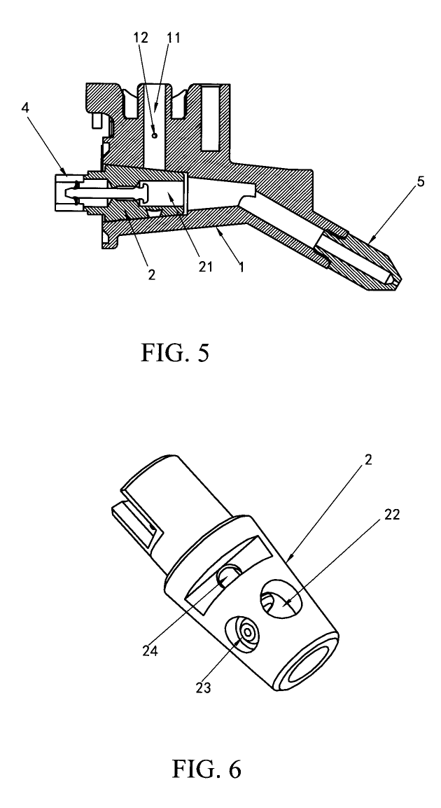

In reference to FIG. 1, FIG. 5 and FIG. 7, valve body 1 has a gas inlet 11 and a gas compensation passage 12, wherein said gas inlet 11 connects said gas compensation passage 12 at one end. A sealing device 6 equipped in gas compensation passage 12 can open or seal the passage. The valve core 2 has a gas source passage 21 connected with a main orifice 22 and an adjacent air-compensation orifice 23, wherein said gas source passage 21 connected with nozzle 5 at one end. The main orifice 22 connects directly to the gas inlet 11. The air-compensation orifice 23 connects to the gas compensation passage 12. A sealing device 6 is provided with a position-limit means 7, wherein said position-limit means 7 controls the operation range of sealing device 6.

FIG. 2 and FIG. 4 show that the present invention adopts a sealing device 6 described here. The sealing device 6 includes a sealing bolt 61 in valve body 1 and a sleeve 62 in gas compensation passage 12, wherein said sealing bolt having a cylinder 61 inserted into sleeve 62 at one end, and said cylinder 611 having a cone 612 at one end. When the gas compensation passage needs to be sealed, by turning the sealing bolt 61, the cone 612 is accordingly inserted in the gas compensation passage 12 to block the passage and cut off gas flow in the gas compensation passage 12. A sealing ring 63 is fitted between the sealing bolt 61 and the sleeve 62. The sleeve 62 has an annular recess 621 on outside lateral wall. The annular recess 621 connects the gas compensation passage 12. In addition, annular recess 621 has an orifice 622 at the bottom. When the sealing bolt 61 is screwed tight, said cone 612 is inserted in the gas compensation passage 12 to cut off the flow in the passage. At this time, said gas compensation passage 12 falls into closed status. When the gas compensation passage needs to be opened, by unscrewing sealing bolt 61, the sealing bolt 61 diverges a certain distance from the sleeve 62, accordingly, the cone 612 diverges from the gas compensation passage 12 and allows fuel gas flow into gas compensation passage 12. Part of the fuel gas flows into gas source passage 21 via gas compensation passage 12 and meets gas from main orifice 22. The confluent fuel gas finally ejects to burner via the nozzle 5 and burns.

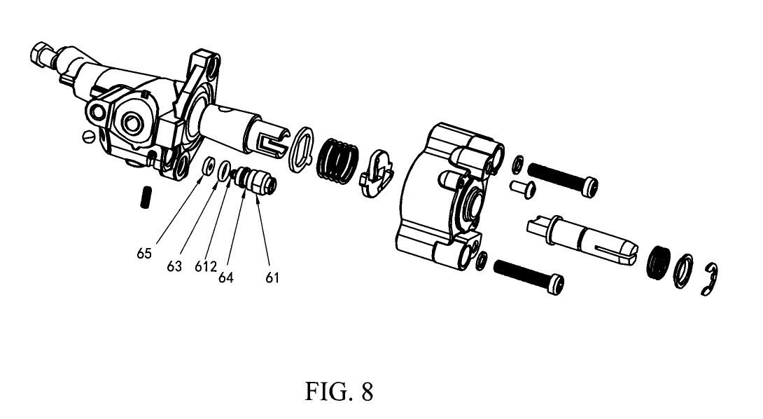

FIG. 8 shows a gas valve adopting another sealing device 6 in the valve body 1 described herein. It illustrates a sealing device 6 including a sealing bolt 61 having an annular recess 64 and a cone 612 at one end, a sealing ring 63 fitted in annular recess 64, a sealing flake 65 connected with the cone 612 at one end. When sealing bolt 61 is screwed tight, said cone 612 is inserted in the gas compensation passage 21, said sealing flake seals the gas compensation passage 21, the cone 612 cuts off gas flow in the gas compensation passage and makes the gas compensation passage in closed status. When the gas compensation passage needs to be opened, by unscrewing the sealing bolt 61, the sealing bolt 61 diverges a certain distance from the sleeve and the cone 612 diverges from the gas compensation passage; simultaneously, the sealing flake 65 is separated from the inlet of gas compensation passage. Part of the fuel gas flows into the gas source passage via the gas compensation passage and meets fuel gas from the main orifice. The confluent fuel gas finally ejects to the burner via the nozzle and burns.

In reference to FIG. 1 and FIG. 4, the present invention adopts a position-limit means 7 including a strip-shape slot 71 mounted aslant on valve body 1 and a position-setting stick 72 inserted into said strip-shape slot 71, wherein said position-setting stick 72 is fixed on the lateral wall of said sealing bolt 61 at one end. The strip-shape slot has a certain length. When turning the sealing bolt 61 to make the position-setting stick 72 move from one end of strip-shape slot 71 to the other, the lateral wall of cylinder 611 changes the orifice 622 into a status between completely sealed and partly sealed; accordingly, the flow of flue gas via gas compensation passage changes from zero value to maximum value. The above-described design can easily control the flow of compensatory fuel gas. Moreover, restricted by position-setting stick 72, the sealing bolt 61 will not easily drop off from the gas compensation passage 12.

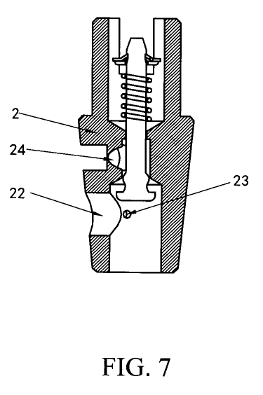

In reference to FIG. 2 and FIG. 6, valve body 1 has a bypass ignition passage 8. Valve core 3 is fitted with the ignition orifice 24 connecting the ignition passage 8.

What is claimed is:

1. A gas valve with dual fuel gas, comprising: a valve body having a valve core, an actuating shaft mounted with a valve core, a nozzle equipped on a valve body and a gas inlet connecting a gas compensation passage, said gas compensation passage fitted with a sealing device used for opening or sealing the gas compensation passage, said valve core fitted with gas source passage, and having a main orifice and an air-compensation orifice connecting to the gas source passage, wherein the sealing device has a position-limit means controlling the operation range of sealing device.

2. The gas valve according to claim 1, wherein said sealing device includes a sealing bolt in the valve body, a sleeve fitted in the gas compensation passage, said sealing bolt having a cylinder inserted into said sleeves at one end, said cylinder inserted into the gas compensation passage at one end to block the gas compensation passage, and a sealing ring equipped between the sealing bolt and sleeve, said sleeve having an annular recess on the outside lateral wall, and said annular recess having an orifice at the bottom, said annular recess connecting with said gas compensation passage.

3. The gas valve according to claim 1, wherein said sealing device includes a sealing bolt in the valve body, said sealing bolt having an annular recess, and a sealing ring fitted in said annular recess, said sealing bolt having a cone at one end, and a sealing flake connecting said cone at one end.

4. The gas valve according to claim 2 wherein the position-limit means includes a strip-shape slot and a position-setting stick, wherein said strip-shape slot mounted aslant on said valve body, said position-setting stick is inserted in said strip-shape slot and fixed on the lateral wall of said sealing bolt at one end.

5. The gas valve according to claim 3 wherein the position-limit means includes a strip-shape slot and a position-setting stick, wherein said strip-shape slot mounted aslant on said valve body, said position-setting stick is inserted in said strip-shape slot and fixed on the lateral wall of said sealing bolt at one end.
